(19) United States
(12) Patent Application Publication
(10) Pub. No.: US 2009/0189947 A1
(43) Pub. Date: Jul. 30, 2009

(54) WASTE LIQUID PROCESSING DEVICE

(75) Inventors: Hideo NORO, Kamiina-gun (JP); Toshio KUMAGAI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/357,968

(22) Filed: Jan. 22, 2009

(30) Foreign Application Priority Data
Jan. 24, 2008 (JP) 2008-013437

(51) Int. Cl. B41J 2/165

(52) U.S. Cl. 347/36

(57) ABSTRACT

Provided is a waste liquid processing device including: a waste liquid tank collecting a liquid cured by irradiation of energy rays as a waste liquid; an irradiation portion irradiating curing energy rays to a liquid level of the waste liquid contained in the waste liquid tank; and an external applying portion applying external force to at least one of the waste liquid tank and the contained waste liquid.

### CROSS-REFERENCE TO RELATED APPLICATIONS

This application claims priority under the Paris Convention based on Japanese Patent Application No. 2008-13437 (filed on Jan. 24, 2008).

### CROSS REFERENCES TO RELATED APPLICATIONS

The present invention contains a subject matter related to Japanese Patent Application No. 2008-13437 filed in the Japanese Patent Office on Jan. 24, 2008, the entire contents of which are incorporated herein by reference.

### BACKGROUND

1. Technical Field

The present invention relates to a waste liquid processing device of an energy ray-curable liquid such as an energy ray-curable ink which is cured by irradiation of energy rays such as ultraviolet (UV) rays, and more particularly, a waste liquid processing device applicable to a liquid ejecting apparatus such as an ink jet recording apparatus for discharging ink droplets from nozzles in correspondence with print data so as to form dots on a recording medium.

2. Related Art

As a liquid ejecting apparatus for ejecting a liquid on a target, an ink jet recording apparatus for ejecting an ink on a recording sheet so as to perform printing is known. Since a recording head of the ink jet recording apparatus ejects an ink pressurized in a pressure generation chamber from nozzles on a recording sheet as ink droplets so as to perform printing, an ejection failure state is generated by the increase of ink viscosity due to the vaporization of a solvent from nozzle openings, the solidification of the ink, the attachment of dust, and the mixture of air bubbles. Thus, a printing failure occurs.

Therefore, the ink jet recording apparatus includes a capping portion for sealing the nozzle openings of the recording head when printing is not performed and a wiping member for cleaning a nozzle forming surface if necessary. This capping portion has a cover function for preventing the ink of the nozzle openings from being dried and a function for solving the clogging of the nozzle openings by sealing the nozzle forming surface by the capping portion and sucking and discharging the ink from the nozzle openings by the negative pressure of a suction pump when the nozzle openings are clogged.

The process of forcedly sucking and discharging the ink in order to solve the clogging of the recording head is called a cleaning operation and is performed, for example, when printing is resumed after the long-term stop of the recording apparatus or when a user recognizes a printing failure and operates a cleaning switch. In addition, the operation for wiping the nozzle forming surface of the recording head is performed by the wiping member made of an elastic plate such as rubber after discharging the ink from the recording head.

In addition, a waste liquid from the recording head, which is contained in the capping portion by the cleaning operation, is dumped into a waste liquid tank by the driving of a suction pump. In the waste liquid tank, a waste liquid absorption material generally made of a porous material is contained and a waste liquid is absorbed by the waste liquid absorption material.

Meanwhile, an ink jet recording method includes an UV ink jet method. The UV ink jet method is a recording method of attaching an energy ray-curable ink, which is cured by the irradiation of energy rays such as ultraviolet (UV) rays, on a recording medium and then curing the energy ray-curable ink by irradiating the energy rays onto the recording medium so as to perform printing.

In the recording apparatus of the UV ink jet method, an apparatus for introducing a waste ink sucked by a cleaning operation into a waste ink bottle, in which an absorber for absorbing an ink is charged, and irradiating ultraviolet rays to a waste ink absorbed in the absorber of the transparent waste ink bottle and curing the waste ink is suggested (JP-A-2004-155047).

However, in JP-A-2004-155047, since the absorber or the cured liquid is not necessarily transparent although the waste liquid container is transparent and the ultraviolet rays are irradiated in a state in which the waste ink is absorbed in the absorber, the ink is rapidly cured in a portion close to the outside of the transparent waste liquid container because the flow of the ultraviolet ray is excellent, but the ink is left in an uncured state at the inside of the waste liquid container because the ultraviolet rays are hard to reach the inside of the waste liquid container.

If the ultraviolet curable liquid includes many materials having skin irritation, has strong irritating odor, and is in an uncured state, the ultraviolet curable liquid has a bad influence on the human body when directly being brought into contact with the skin of a person. In addition, a working environment is bad due to irritating odor. However, if the ultraviolet curable liquid is cured, the ultraviolet curable liquid becomes harmless and irritating odor is suppressed. Accordingly, if the ultraviolet curable liquid is left in the uncured state like the apparatus of JP-A-2004-155047, the stability or the comfort of the working environment cannot be ensured when the waste liquid container is collected and an incineration treatment is performed.

If the liquid is cured in a state of being absorbed in the absorber, the next collected liquid is hard to be absorbed in the absorber and thus the waste liquid cannot be collected although a surplus capacity exists in the collection amount of the waste liquid container. In this case, since a deviation occurs by the absorption state or the curing state of the waste liquid, the life span of the waste liquid tank is not constant and replacement timing cannot be adequately informed to a user.

### SUMMARY

An advantage of some aspects of the invention is that it provides a waste liquid processing device capable of converting a liquid into a harmless solid with certainty, collecting the solid and stably and readily performing a waste liquid process.

According to an aspect of the invention, there is provided a waste liquid processing device including: a waste liquid tank collecting a liquid cured by irradiation of energy rays as a waste liquid; an irradiation portion irradiating curing energy rays to a liquid level of the waste liquid contained in the waste liquid tank; and an external applying portion applying external force to at least one of the waste liquid tank and the contained waste liquid.

The waste liquid processing device of the invention irradiates the curing energy rays to the liquid level of the waste liquid contained in the waste liquid tank and applies external force to at least one of the waste liquid tank and the contained waste liquid. Accordingly, the waste liquid in the vicinity of the liquid level is sequentially cured by the irradiation of the energy rays like ice-up. At this time, since the external force is applied to at least one of the waste liquid tank and the contained waste liquid and motion such as vibration or flowage is applied to the liquid level by the external force, the resin cured in the liquid level is not adhered to the inner wall surface of the waste liquid tank. In addition, since the cured resin has specific gravity higher than that of a liquid uncured by shrinkage due to polymerization, the cured resin deposits on the bottom of the waste liquid tank. Then, a new liquid level is exposed and the curing is started in the vicinity of the liquid level again by additionally irradiating the curing energy rays. By repeating such an operation, the waste liquid contained in the waste liquid tank is completely cured and an uncured portion is not left. The stability or the comfort of the work in the collection and processing of the waste liquid tank can be ensured. In addition, since the waste liquid is introduced from the waste liquid introduction port located above the liquid level, the cured resin sequentially deposits on the bottom. Since next waste liquids are sequentially introduced from the upper side of the liquid surface and the cured resin is sequentially laminated from the bottom of the reception space in the tank, a deviation does not occur in the collection amount by the absorption state or the curing state of the waste liquid and thus the replacement timing of the waste liquid tank can be adequately informed to a user.

In the invention, if the external applying portion moves the liquid level of the waste liquid contained in the waste liquid tank relative to an inner wall surface of the waste liquid tank, it is possible to prevent the resin cured in the liquid level from being adhered to the inner wall surface of the waste liquid tank with certainty and ensure stability or comfort of a work in the collection and processing of the waste liquid tank by completely curing the waste liquid contained in the waste liquid tank.

In the invention, if the external applying portion moves a boundary between the inner wall surface of the waste liquid tank and the liquid level relative to the inner wall surface, it is possible to prevent the resin cured in the liquid level from being adhered to the inner wall surface of the waste liquid tank with certainty and ensure stability or comfort of a work in the collection and processing of the waste liquid tank by completely curing the waste liquid contained in the waste liquid tank.

In the invention, if the external applying portion rotates the waste liquid tank around a predetermined axis, it is possible to prevent the resin cured in the liquid level from being adhered to the inner wall surface of the waste liquid tank by a simple structure with certainty. In addition, in this case, if the waste liquid tank has an approximately cylindrical shape and rotates around the axis of the cylindrical shape, a rotation space of the waste liquid tank is not required. Thus, the device is not enlarged and is compact.

In the invention, if the external applying portion applies vibration to at least one of the waste liquid tank and the contained waste liquid, it is possible to prevent the resin cured in the liquid level from being adhered to the inner wall surface of the waste liquid tank with certainty and ensure stability or comfort of a work in the collection and processing of the waste liquid tank by completely curing the waste liquid contained in the waste liquid tank.

In the invention, if the external applying portion shakes the waste liquid tank, it is possible to prevent the resin cured in the liquid level from being adhered to the inner wall surface of the waste liquid tank with certainty and ensure stability or comfort of a work in the collection and processing of the waste liquid tank by completely curing the waste liquid contained in the waste liquid tank.

In the invention, if a motion promoting portion promoting motion of the liquid level, which occurs by external force, is provided in the waste liquid tank, the motion of the liquid level in the waste liquid tank, which occurs by the rotation of the waste liquid tank, is promoted such that the resin cured in the liquid level can be prevented from being adhered to the inner wall surface of the waste liquid tank by a simple structure with certainty. In addition, since the energy rays are irradiated while the liquid level is moved and the cured resin does not become an agglomerate and deposits on the bottom of the waste liquid tank, the uncured waste liquid is hard to be left in a gap between uncured resins and thus the waste liquid contained in the waste liquid tank can be completely cured.

### BRIEF DESCRIPTION OF THE DRAWINGS

The invention will be described with reference to the accompanying drawings, wherein like numbers reference like elements.

FIG. 1 is a view showing the schematic configuration of a recording apparatus according to the invention.

FIG. 2 is a partial cross-sectional view showing the configuration of a waste liquid processing device according to the present embodiment.

FIGS. 3A-3C are views explaining the operation of the waste liquid processing device.

FIGS. 4A-4F are views showing a second embodiment.

FIGS. 5A-5E are views showing third to seventh embodiments.

### DESCRIPTION OF EXEMPLARY EMBODIMENTS

Next, embodiments of the invention will be described in detail.

Hereinafter, an embodiment in which a waste liquid processing device of the invention is applied to an ink jet recording apparatus as a liquid ejecting apparatus will be described with reference to the accompanying drawings.

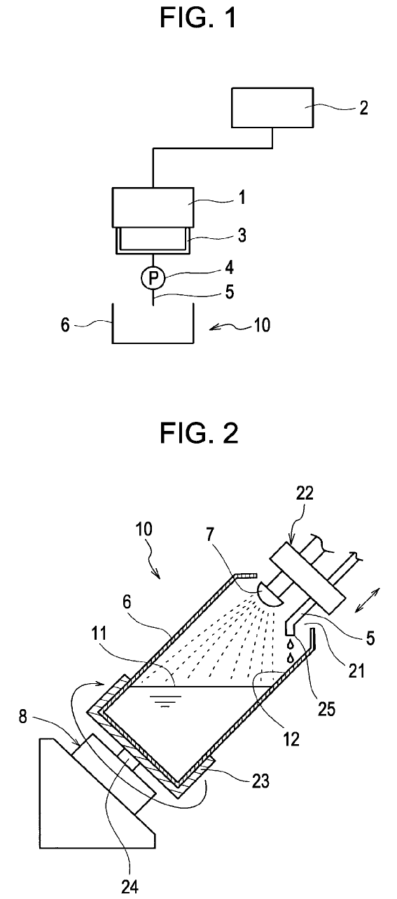

FIG. 1 is a view showing the configuration of main portions of an ink jet recording apparatus according to the invention.

In the drawing, a reference numeral 1 is an ejection head 1 which receives an ink from an ink cartridge 2 as an ink tank and ejects ink droplets from nozzles to a target (not shown) so as to perform recording. In addition, a reference numeral 3 is a capping portion 3 arranged outside a recording area. This capping portion 3 is connected to a suction pump 4 for applying negative pressure to an internal space of the capping portion 3.

The capping portion 3 functions as a cover for sealing a nozzle forming surface of the ejection head 1 during an idle period of the recording apparatus and preventing the nozzles from being dried and function as a cleaning unit for applying negative pressure from the suction pump 4 to the ejection head 1 so as to suck and discharge the ink from the ejection head 1.

By the above-described configuration, when the ink cartridge 2 is replaced or the nozzles of the ejection head 1 are clogged, upon start-up after being left for a long period of time, the nozzle forming surface of the ejection head 1 is capped by the capping portion 3 and is sucked by the suction pump 4 such that the ink are forcedly sucked and discharged, and the thickened ink or air bubbles in the ejection head 1 are sucked and discharged so as to maintain the ejection characteristics of the ejection head 1.

The ink discharged from an ink discharge passage 5 by the suction of the suction pump 4 is introduced into a waste liquid tank 6, and is cured by a waste liquid processing device 10 of the invention including the waste liquid tank 6.

In this example, as the ink, an energy ray-curable liquid such as an energy ray-curable ink which is cured by the irradiation of energy rays such as ultraviolet (UV) rays is used. For example, an ultraviolet curable ink is used and includes, for example, ultraviolet curable resin (5 to 10%), pigment (5 to 10%), an additive agent for performing stable printing by ink jet (about 20%) and water (60 to 70%).

FIG. 2 is a view showing the configuration of the waste liquid processing device 10.

This waste liquid processing device 10 includes the waste liquid tank 6 for collecting a liquid cured by the irradiation of the energy rays as a waste liquid, an irradiation portion 7 for irradiating the curing energy rays to a liquid level 11 of the waste liquid contained in the waste liquid tank 6, and a rotation driving portion 8 for moving the liquid level 11 of the waste liquid contained in the waste liquid tank 6 relative to an inner wall surface 12 of the waste liquid tank 6. The rotation driving portion 8 functions as an external force applying portion for applying external force to at least one of the waste liquid tank 6 and the contained waste liquid.

In more detail, the waste liquid tank 6 is formed in a bottle shape which is a cylindrical shape having an opening 21 formed at the upper side thereof, and an irradiation unit 22 to which the irradiation portion 7 and the ink discharge passage 5 are attached so as to correspond to the opening 21 formed at the upper side thereof is provided. The bottom of the waste liquid tank 6 is detachably attached to a tank holder 23.

Meanwhile, the rotation driving portion 8 functioning as the external force applying portion rotates around a predetermined axis of the waste liquid tank 6.

That is, the tank holder 23 is fixed to a rotation shaft 24 of the rotation driving portion 8 such that the axis thereof is coaxial with the rotation shaft 24. In addition, the waste liquid tank 6 is attached to the tank holder 23 such that the axis of the cylindrical tank is coaxial with the tank holder. Accordingly, the waste liquid tank 6 rotates around the axis of the waste liquid tank 6 having the approximately cylindrical shape by rotating the tank holder 23 by the rotation driving portion 8. Since the waste liquid tank 6 has the approximately cylindrical shape and rotates around the axis of the cylindrical shape, a rotation space of the waste liquid tank 6 is not required. Thus, the device is not enlarged and is compact.

The rotation driving portion 8 is arranged such that the rotation shaft 24 and the tank holder 23 are inclined and the axis of the waste liquid tank 6 is inclined, and is rotated around the axis thereof in a state of being inclined.

Meanwhile, the irradiation portion 7 for irradiating ultraviolet rays (UV light) as energy rays is attached to the irradiation unit 22. As the irradiation unit 7, for example, a light-emitting diode (LED) for emitting light in an ultraviolet band may be used. The ink discharge passage 5 which is connected to the suction pump 4 for discharging the waste liquid from the capping portion 3 is attached to the irradiation unit 22.

The irradiation unit 22 is configured to advance/retreat to/from the opening 21 of the waste liquid tank 6. Accordingly, when the irradiation portion 7 and a waste liquid introduction port 25 of the ink discharge passage 5 are arranged in the opening 21 of the waste liquid tank 6, the irradiation unit 22 advances to the opening 21 of the waste liquid tank 6 (the state of FIG. 2) and, when the attachment/detachment or the replacement of the waste liquid tank 6 is performed, the irradiation unit 22 retreats from the opening 21 of the waste liquid tank 6.

The irradiation portion 7 irradiates the curing energy rays to the liquid level 11 of the waste liquid contained in the waste liquid tank 6 at the position where the irradiation unit 22 advances to the opening 21 of the waste liquid tank 6. In addition, at that position, the waste liquid introduction port 25 of the ink discharge passage 5 is attached to the irradiation unit 22 such that the waste liquid is introduced into a reception space of the waste liquid tank 6. At this time, in the positional relationship between the ink discharge passage 5 and the irradiation portion 7, the irradiation portion 7 is located above the waste liquid introduction port 25 of the ink discharge passage 5 such that the ink discharged from the waste liquid introduction port 25 of the ink discharge passage 5 is prevented from being cured across the irradiation portion 7 so as to deteriorate irradiation efficiency.

By the above-described configuration, the waste liquid processing device 10 performs the waste liquid processing as follows.

That is, in the ink jet recording apparatus, when the ink cartridge 2 is replaced or the nozzles of the ejection head 1 are clogged, at a predetermined suction timing, such as start-up after being left for a long period of time, the nozzle forming surface of the ejection head 1 is capped by the capping portion 3 and is sucked by the suction pump 4 such that the ink is forcedly sucked and discharged.

The sucked ink is introduced from the waste liquid introduction port 25 of the ink discharge passage 5 into the waste liquid tank 6. A control portion (not shown) starts and controls the rotation of the waste liquid tank 6 by the rotation driving portion 8 and starts and controls and the irradiation of the energy rays from the irradiation portion 7 at a timing when the ink is sucked and the waste liquid is introduced into the waste liquid tank 6.

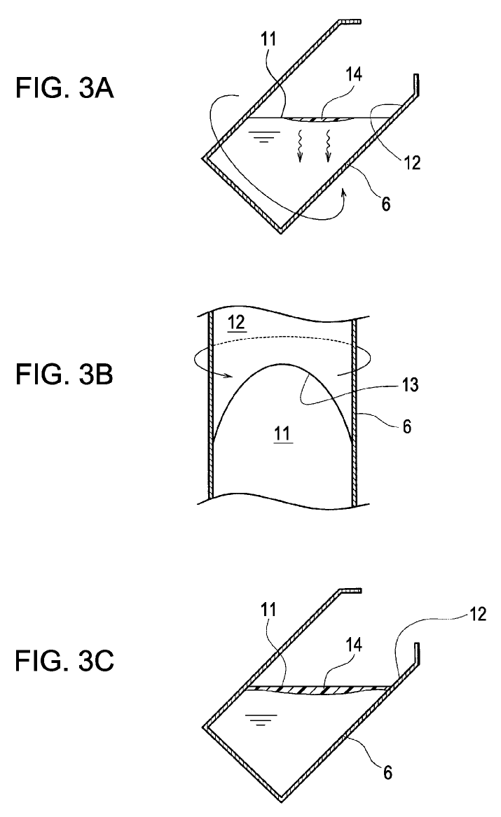

FIGS. 3A-3C are views explaining a state in which the energy rays are irradiated to the liquid level 11 by the irradiation portion 7 while the waste liquid tank 6 rotates.

As shown in FIG. 3A, when the energy rays are irradiated to the liquid level 11 of the waste liquid by the irradiation portion 7, the waste liquid in the vicinity of the liquid level 11 is sequentially cured by the irradiation of the energy rays like ice-up such that a thin resin plate 14 is formed.

As shown in FIG. 3B, the rotation driving portion 8 functioning as the external force applying portion moves the liquid level 11 relative to the inner wall surface 12 of the waste liquid tank 6 and moves a boundary 13 between the inner wall surface 12 of the waste liquid tank 6 and the liquid level 11 relative to the inner wall surface 12. Accordingly, the waste liquid tank 6 rotates in the inclined state such that the liquid level 11 always moves relative to the inner wall surface 12 of the waste liquid tank 6 without staying at a predetermined place. In addition, the boundary 13 between the inner wall surface 12 of the waste liquid tank 6 and the liquid level 11 always moves relative to the inner wall surface 12 of the rotated waste liquid tank 6 without staying at a predetermined place. That is, the rotation driving portion 8 functioning as the external force applying portion applies external force to the waste liquid tank 6 and rotates the waste liquid tank such that motion such as vibration or flowage is applied to the liquid level 11 of the waste liquid. Accordingly, the resin plate 14 cured in the vicinity of the liquid level 11 is not adhered to the inner wall surface 12 of the waste liquid tank 6.

As shown in FIG. 3C, if the energy rays are irradiated to the liquid level 11 of the waste liquid by the irradiation portion 7 without using the rotation driving portion 8 and the liquid level 11 is not moved relative to the inner wall surface 12 of the waste liquid tank 6, that is, the external force is not applied to the waste liquid tank 6 in order to move the liquid level, the resin plate 14 cured in the vicinity of the liquid level 11 is adhered to the inner wall surface 12 of the waste liquid tank 6. If the entire liquid level 11 is covered by the cured resin plate 14, although the energy rays are irradiated to the liquid level 11 thereafter, the energy rays are hard to reach the uncured ink located below the resin plate 14 and thus the uncured waste liquid is left.

In the waste liquid processing device 10 of the present embodiment, since the resin plate 14 cured in the vicinity of the liquid level 11 is not adhered to the inner wall surface 12 of the waste liquid tank 6 and the cured resin has specific gravity higher than that of a liquid uncured by shrinkage due to polymerization, the cured resin deposits on the bottom of the waste liquid tank 6. Then, a new liquid level 11 is exposed and the curing is started in the vicinity of the liquid level 11 again by additionally irradiating the curing energy rays. By repeating such an operation, the waste liquid contained in the waste liquid tank 6 is completely cured and an uncured portion is not left. The stability or the comfort of the work in the collection and processing of the waste liquid tank can be ensured.

In addition, since the waste liquid is introduced from the waste liquid introduction port 25 located above the liquid level 11, the cured resin sequentially deposits on the bottom. Since next waste liquids are sequentially introduced from the upper side of the liquid level 11 and the cured resin is sequentially laminated from the bottom of the reception space in the waste liquid tank 6, a deviation does not occur in the collection amount by the absorption state or the curing state of the waste liquid and thus the replacement timing of the waste liquid tank 6 can be adequately informed to a user.

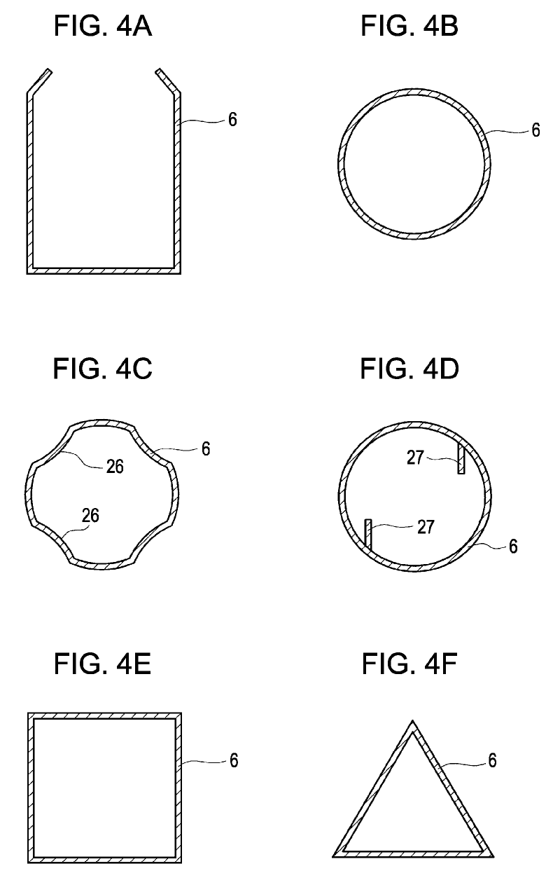

FIGS. 4A-4F are views showing a waste liquid tank 6 applied to a waste liquid processing device according to a second embodiment of the invention.

FIG. 4A is a longitudinal cross-sectional view of the waste liquid tank 6 and FIG. 4B is a lateral cross-sectional view of the waste liquid tank 6 having the cylindrical shape, which is shown in the first embodiment.

As shown in FIGS. 4C to 4F, an agitating promoting portion for promoting agitating of a waste liquid, which occurs by rotation of the waste liquid tank 6, may be provided in the waste liquid tank 6.

In FIG. 4C, swelling portions 26 which swell from the circumferential wall of the waste liquid tank 6 toward the inside thereof are formed at plural places (four places, in this example). The swelling portions 26 are formed to extend in an axial direction, and promotes the motion of the liquid level, that is, the agitating of the waste liquid, which occurs by the rotation of the waste liquid tank 6, when the waste liquid tank 6 in which the waste liquid is contained rotates around the axis of the cylindrical shape. That is, in this example, the swelling portions 26 function as the agitating promoting portion.

In FIG. 4D, agitating blades 27 which extend toward the inside thereof at plural places (two places, in this example) of the circumferential wall of the waste liquid tank 6 is attached. The agitating blades 27 are formed to extend in the axial direction, and promotes the motion of the liquid level, that is, the agitating of the waste liquid, which occurs by the rotation of the waste liquid tank 6, when the waste liquid tank 6 in which the waste liquid is contained rotates around the axis of the cylindrical shape. That is, in this example, the agitating blades 27 function as the motion promoting portion.

In FIG. 4E, the circumferential wall of the waste liquid tank 6 is formed in a rectangular shape in a lateral cross section perpendicular to the axis and, in FIG. 4F, the circumferential wall of the waste liquid tank 6 is formed in a triangular shape in the lateral cross section perpendicular to the axis. By varying the cross section of the circumferential wall of the waste liquid tank 6, it is possible to promote the motion of the liquid level, that is, the agitating of the waste liquid, which occurs by the rotation of the waste liquid tank 6, when the waste liquid tank 6 in which the waste liquid is contained rotates around the axis of the cylindrical shape. That is, in this case, the circumferential wall functions as the motion promoting portion. In addition, the shape of the cross section of the circumferential wall of the waste liquid tank 6 is not limited to the above-described shapes and various shapes such as elliptical shape, a pentagonal shape, a hexagonal shape and an octagonal shape may be employed.

By providing the motion promoting portion for promoting the motion of the liquid level, that is, the agitating of the waste liquid, which occurs by the rotation of the waste liquid tank 6, in the waste liquid tank 6, the resin cured in the liquid level can be prevented from being adhered to the inner wall surface of the waste liquid tank 6 by a simple structure with certainty. In addition, since the energy rays are irradiated while the waste liquid is agitated and the cured resin does not become an agglomerate and deposits on the bottom of the waste liquid tank 6, the uncured waste liquid is hard to be left in a gap between cured resins and thus the waste liquid contained in the waste liquid tank 6 can be completely cured.

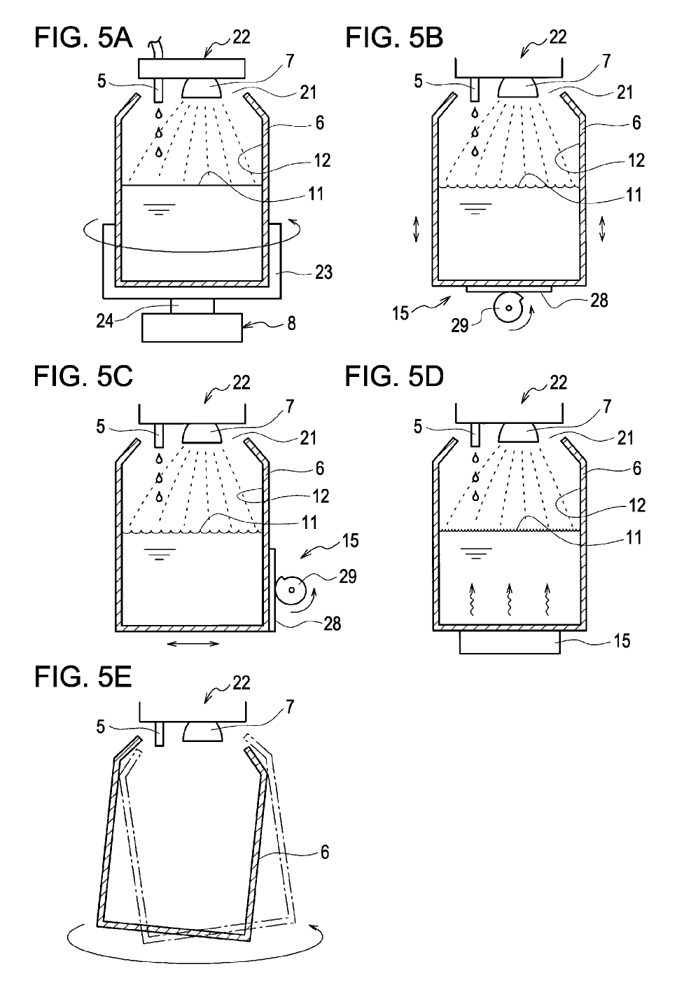

FIG. 5A shows a waste liquid processing device according to a third embodiment of the invention. In this embodiment, the axis of a waste liquid tank 6 having a cylindrical shape is arranged along a vertical direction and the waste liquid tank 6 rotates around the vertical axis. The other portions are equal to those of the above-described embodiments and the same portions are denoted by the same reference numerals.

Even in this embodiment, the rotation driving portion 8 functioning as the external force applying portion moves the liquid level 11 of the waste liquid contained in the waste liquid tank 6 relative to the inner wall surface 12 of the waste liquid tank 6. That is, the liquid in the vicinity of the inner wall surface 12 rotates with a slight delay from the inner wall surface 12 by the rotation of the inner wall surface 12 of the waste liquid tank 6, and the delay is increased toward the center of the liquid level, that is, the axis. Accordingly, the liquid level 11 does not move by completely following the motion of the inner wall surface 12 and the liquid level 11 moves relative to the inner wall surface 12. In addition, the liquid level 11 moves by the rotation of the waste liquid tank 6. Even in this embodiment, the same effects as the above-described embodiments are obtained.

FIG. 5B shows a waste liquid processing device according to a fourth embodiment of the invention. In this embodiment, a vibration applying portion 15 for applying vibration to at least one of a waste liquid tank 6 and a contained waste liquid is included as an external force applying portion.

In this embodiment, the vibration applying portion 15 includes a contact member 28 provided on the bottom of the waste liquid tank 6 and a cam member 29 which rotates while being in contact with the contact member 28. By rotating the cam member 29 while being in contact with the contact member 28, vertical vibration is applied to the waste liquid tank 6. The other portions are equal to those of the above-described embodiments and the same portions are denoted by the same reference numerals.

Even in this embodiment, the vibration applying portion 15 functioning as the external force applying portion moves the liquid level 11 of the waste liquid contained in the waste liquid tank 6. That is, the inner wall surface 12 of the waste liquid tank 6 vertically vibrates by the vibration applying portion 15 and thus the liquid level 11 vibrates. The vibration of the liquid level 11 does not completely follow the vibration of the inner wall surface 12 and the liquid level 11 waves and moves relative to the inner wall surface 12. Even in this embodiment, the same effects as the first embodiments are obtained.

FIG. 5C shows a waste liquid processing device according to a fifth embodiment of the invention. In this embodiment, a vibration applying portion 15 for applying vibration to at least one of a waste liquid tank 6 and a contained waste liquid is included as an external force applying portion.

In this embodiment, the vibration applying portion 15 includes a contact member 28 provided on the side surface of the waste liquid tank 6 and a cam member 29 which rotates while being in contact with the contact member 28. By rotating the cam member 29 while being in contact with the contact member 28, horizontal vibration is applied to the waste liquid tank 6. The other portions are equal to those of the above-described embodiments and the same portions are denoted by the same reference numerals.

Even in this embodiment, the vibration applying portion 15 functioning as the external force applying portion moves the liquid level 11 of the waste liquid contained in the waste liquid tank 6. That is, the inner wall surface 12 of the waste liquid tank 6 horizontally vibrates by the vibration applying portion 15 and thus the liquid level 11 shakes. The shaking of the liquid level 11 does not completely follow the vibration of the inner wall surface 12 and the liquid level 11 waves and moves relative to the inner wall surface 12. Even in this embodiment, the same effects as the above-described embodiments are obtained.

FIG. 5D shows a waste liquid processing device according to a sixth embodiment of the invention. In this embodiment, a vibration applying portion 15 for applying vibration to at least one of a waste liquid tank 6 and a contained waste liquid is included as an external force applying portion.

In this embodiment, the vibration applying portion 15 includes an ultrasonic vibrator for applying ultrasonic vibration to the bottom of the waste liquid tank 6. The ultrasonic vibration is applied to the waste liquid tank 6 and a waste liquid by the vibration of the ultrasonic vibrator. The other portions are equal to those of the above-described embodiments and the same portions are denoted by the same reference numerals.

Even in this embodiment, the ultrasonic vibrator functioning as the external force applying portion moves the liquid level 11 of the waste liquid contained in the waste liquid tank 6. That is, the inner wall surface 12 of the waste liquid tank 6 performs ultrasonic vibration by the ultrasonic vibration and thus the liquid level 11 performs ultrasonic vibration. The ultrasonic vibration of the liquid level 11 does not completely follow the ultrasonic vibration of the inner wall surface 12 and the liquid level 11 moves relative to the inner wall surface 12. Even in this embodiment, the same effects as the above-described embodiments are obtained.

FIG. 5F shows a waste liquid processing device according to a seventh embodiment of the invention. In this embodiment, a shaking portion (not shown) for shaking a waste liquid tank 6 is included as an external force applying portion. The waste liquid tank 6 shakes by the shaking portion. The other portions are equal to those of the above-described embodiments and the same portions are denoted by the same reference numerals.

Even in this embodiment, the shaking portion functioning as the external force applying portion moves the liquid level 11 of the waste liquid contained in the waste liquid tank 6. That is, the inner wall surface 12 of the waste liquid tank 6 vertically and horizontally is shaken by the shaking portion and thus the liquid level 11 shakes. The shaking of the liquid level 11 does not completely follow the shaking of the inner wall surface 12 and the liquid level 11 waves and moves relative to the inner wall surface 12. Even in this embodiment, the same effects as the above-described embodiments are obtained.

Although, in the above-described embodiments, an LED for emitting light in an ultraviolet band is described as the irradiation portion 7, the invention is not limited to this. As the irradiation portion 7, for example, various types of energy ray irradiating units such as a metal halide lamp, a xenon lamp, a carbon arc lamp, a chemical lamp, a low-pressure mercury lamp, and a high-pressure mercury lamp may be used.

In the above-described embodiments, the energy rays may be irradiated onto the entire surface of the liquid level or the energy rays may be focused by, for example, a lens or the like and partially irradiated to a portion of the liquid level, when the irradiation portion 7 irradiates the curing energy rays to the liquid level of the waste liquid contained in the waste liquid tank 6.

In addition, although, in the above-described embodiments, the cylindrical tank of which the upper surface is opened is used as the waste liquid tank 6, the invention is not limited to this. An internal space may be sealed by an outer part constructing member including a cover member. In this case, in the internal space, a waste liquid introduction port 25 for receiving the waste liquid from the recording apparatus or the irradiation portion 7 may be provided in a ceiling portion. In addition, the cover member may be formed of an ultraviolet transmission member such as a transparent member and the irradiation portion 7 may be provided above the cover member.

In the above-described embodiments, the ejection head 1 is applicable to a liquid ejecting apparatus using a piezoelectric vibrator or a liquid ejecting apparatus using a heating element, as a pressure generation element which is a driving element for ejecting a liquid.

In addition, a representative example of the liquid ejecting apparatus includes the above-described ink jet recording apparatus including an ink jet recording head for recording an image. The invention is, for example, applicable to various types of liquid ejecting apparatuses, such as an apparatus including a coloring material ejecting head used for manufacturing color filters of a liquid crystal display and the like; an apparatus including an electrode material (conductive paste) ejecting head used for forming electrodes of an organic EL display, a field emission display (FED) and the like; an apparatus including a bio-organic matter ejecting head used for manufacturing biochips; and an apparatus including a sample ejecting head as precision pipette; and the like, as the other liquid ejecting apparatuses.

What is claimed is:

1. A waste liquid processing device comprising:
a waste liquid tank collecting a liquid cured by irradiation of energy rays as a waste liquid;
an irradiation portion irradiating curing energy rays to a liquid level of the waste liquid contained in the waste liquid tank; and
an external applying portion applying external force to at least one of the waste liquid tank and the contained waste liquid.

2. The waste liquid processing device according to claim 1, wherein the external applying portion moves the liquid level of the waste liquid contained in the waste liquid tank relative to an inner wall surface of the waste liquid tank.

3. The waste liquid processing device according to claim 2, wherein the external applying portion moves a boundary between the inner wall surface of the waste liquid tank and the liquid level relative to the inner wall surface.

4. The waste liquid processing device according to claim 1, wherein the external applying portion rotates the waste liquid tank around a predetermined axis.

5. The waste liquid processing device according to claim 1, wherein the external applying portion applies vibration to at least one of the waste liquid tank and the contained waste liquid.

6. The waste liquid processing device according to claim 1, wherein the external applying portion shakes the waste liquid tank.

7. The waste liquid processing device according to claim 1, wherein a motion promoting portion promoting motion of the liquid level, which occurs by external force, is provided in the waste liquid tank.

8. A liquid ejecting apparatus comprising the waste liquid processing device according to claim 1.
